(19) United States
(12) Patent Application Publication
(10) Pub. No.: US 2022/0018102 A1
(43) Pub. Date: Jan. 20, 2022

(54) FIRE HYDRANT WITH SOLAR-POWERED HEATING

(71) Applicant: Elizabeth Ann Kelley, Concord, NH (US)

(72) Inventor: Elizabeth Ann Kelley, Concord, NH (US)

(21) Appl. No.: 17/302,208

(22) Filed: Apr. 27, 2021

Related U.S. Application Data
(60) Provisional application No. 62/705,804, filed on Jul. 16, 2020.

(51) Int. Cl. E03B 9/06; H05B 3/00; H02S 20/10; H02S 40/38

(52) U.S. Cl. CPC E03B 9/06; H02S 40/38; H02S 20/10; H05B 3/0014

(57) ABSTRACT

A fire hydrant assembly and fire hydrant system are disclosed. The fire hydrant assembly includes a fire hydrant, a water pipe, a thermal insulating liner, and a power source. The water pipe is operably connected to the fire hydrant. The thermal insulating liner at least partially wrapped around the water pipe. The power source is coupled to the fire hydrant and electrically connected to the thermal insulating liner. The fire hydrant system may further include a hydrant connection valve disposed under a ground surface and connected to the water pipe.

### CROSS-REFERENCE TO RELATED APPLICATION

This application claims the benefit of priority of U.S. provisional application No. 62/705,804, filed Jul. 16, 2020, the contents of which are herein incorporated by reference.

### BACKGROUND OF THE INVENTION

The present invention relates to fire hydrants and, more particularly, to a solar power thermal insulated fire hydrant.

First responders/fire fighters are critically important workers who have to be out in all weather conditions when called into service. Added challenges occur in sub-freezing temperatures due to frozen fire hydrants (whether it is the hydrant itself or the water line) which is, of course, a major problem. If a water pipe in a hydrant is frozen, it will be more difficult to battle a fire, should one occur, thus endangering the lives of fire fighters and individuals trapped in the burning building.

Typically, in extremely cold weather, fire departments may need to send as many as three engines out to carry thousands of gallons of water and to look for an unfrozen hydrant. This requires significantly more resources, and results in a loss of time actually fighting the fire as opposed to searching for an unfrozen hydrant. If no unfrozen hydrants are found, the only option for the firefighters is to use the water available on the fire engine and hope that it is sufficient to put out the fire. However, thousands of gallons of water can be exhausted in just a few minutes. Further, the loss of time due to searching for a usable hydrant can have tragic consequences, such as loss of life, additional damage to property, etc.

As can be seen, there is a need for a device that keeps the lining of a hydrant warm to prevent freezing.

### SUMMARY OF THE INVENTION

In one aspect of the present invention, a fire hydrant assembly comprises a fire hydrant; a water pipe operably connected to the fire hydrant; a thermal insulating liner at least partially wrapped around the water pipe; and a power source coupled to the fire hydrant and electrically connected to the thermal insulating liner.

In certain embodiments of the fire hydrant assembly, the power source may be a renewable energy power source. The renewable energy power source may be embodied as at least one solar panel, and the fire hydrant assembly may further comprise a battery configured to receive electrical energy from the at least one solar panel. According to embodiments of the present invention, the thermal insulating liner may surround a circumference of the water pipe. The thermal insulating liner may be configured to heat the water pipe for preventing water disposed in the water pipe from freezing. In certain embodiments, the power source may be embedded in a recess formed in the hydrant. In certain embodiments, the power source is at least one solar panel embedded in a cap of the fire hydrant.

In another aspect of the present invention, a fire hydrant system comprises: a fire hydrant assembly comprising a fire hydrant; a water pipe operably connected to the fire hydrant; a thermal insulating liner at least partially wrapped around the water pipe; and a power source coupled to the fire hydrant and electrically connected to the thermal insulating liner; and the fire hydrant system further comprises a hydrant connection valve disposed under a ground surface and connected to the water pipe.

In certain embodiments for the fire hydrant system, the thermal insulating liner extends beyond the hydrant connection valve. The thermal insulating liner may terminate proximal a supply main water pipe. The thermal insulating liner may be configured to heat the water pipe for preventing water disposed in the water pipe from freezing. The power source may be at least one solar panel. The fire hydrant system may further comprise a battery configured to receive electrical energy from the at least one solar panel. The power source of the fire hydrant system may be embedded in a recess formed in the fire hydrant.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a schematic view of the embodiment of the present invention, shown in use;

FIG. 3 is an enlarged detail view illustrating a thermal insulating line of the embodiment of the present invention;

FIG. 4 is an exploded perspective view of solar panels and a hydrant of the embodiment of the present invention; and

FIG. 5 is a perspective view of an alternative embodiment of the present invention.

### DETAILED DESCRIPTION OF THE INVENTION

The following detailed description is of the best currently contemplated modes of carrying out exemplary embodiments of the present invention. The description is not to be taken in a limiting sense but is made merely for the purpose of illustrating the general principles of the present invention, since the scope of the present invention is best defined by the appended claims.

Broadly, an embodiment of the present invention provides a fire hydrant assembly comprising: a fire hydrant; a water pipe operably connected to the fire hydrant; a thermal insulating liner at least partially wrapped around the water pipe; a power source (e.g., one or more solar panels) coupled to the fire hydrant and electrically connected to the thermal insulating liner.

In accordance with certain aspects of the present invention, a power source is integrated with a hydrant (such as solar panels that are integrated on the cap of the hydrant) to warm a thermal insulated liner of the hydrant to keep water from freezing when there are very low temperatures, such as, sub-zero degree temperatures. By doing so, the fire hydrants will always be ready for use when a fire fighter needs to put out a fire. Embodiments of the present invention are particularly of use in remote northern regions like Alaska, northern New England, Canada and other places/regions that experience very low temperatures and may not always have easy access to grid electricity in every location. However, it will be appreciated that embodiments of the present invention may be used anywhere frozen pipes may be of concern, which includes warmer regions that may experience freezing temperatures in the winter, for example.

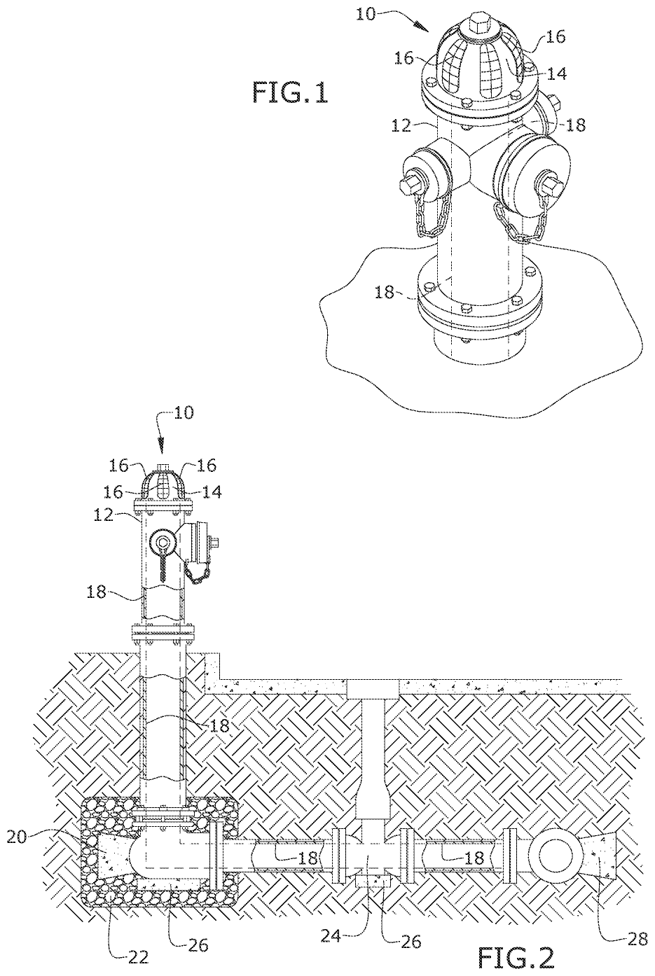

Referring now to FIGS. 1-4, a first embodiment of a hydrant cap assembly 10 is disclosed. The hydrant cap assembly 10 includes a hydrant 12, a cap 14, a plurality of power sources (embodied as solar panels 16 in the present invention) disposed on the cap 14, and a thermal insulating liner 18. In use, the solar panels 16 absorb the sun's rays and convert them into electricity. In certain embodiments, the excess energy produced by the solar panels 16 may be stored (such as via a battery) so that the excess energy may be stored for use at night and other times when less solar energy is being collected by the solar panels 16. The solar panels 16 may be embedded in recesses (or grooves) 30, as shown in FIG. 4, which better ensure their engagement with the hydrant 12. Further, as shown in FIG. 5, the solar panels 16 may be embodied as a cap/single piece 32 for additional collection of solar energy, with the other details of the previously described embodiment being consistent with the embodiment shown in FIG. 5.

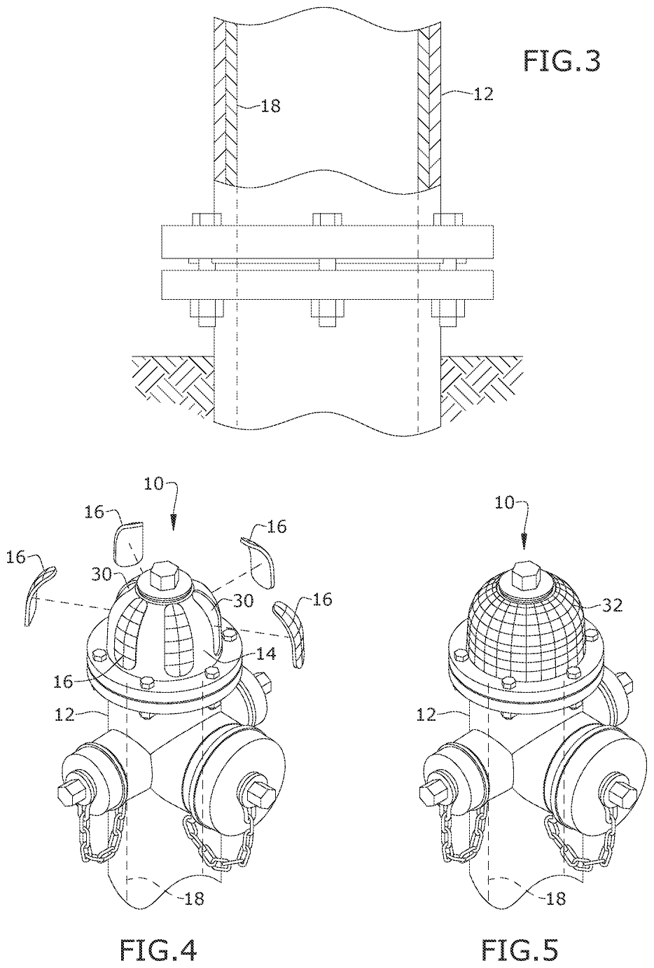

As shown in FIG. 1, the thermal insulating liner 18 extends from the fire hydrant into the ground and surrounds the water pipe(s) (the dashed lines in FIGS. 2-3 are generally illustrative of a pipe system) that run within the hydrant and beneath ground level. This design ensures that not only will the pipes above ground be kept from potentially freezing, but also the pipes disposed underground. For the purposes of clarity of illustration, the liner 18 is shown as discontinuous, but it should be understood that it may be embodied as a continuous (or substantially continuous) liner 18 extending from the hydrant 12 to a supply main (illustrated proximal a downstream thrust block 28). The liner 18, of course, may also be provided in a plurality of pieces to achieve the same functional end as a single liner, and may only be designed to cover a portion of the water pipe(s). The thermal insulating liner 18 is electrically connected to the solar panels 16 such that solar energy collected by the solar panels 16 powers the thermal insulating liner 18 to keep the water pipes above freezing.

According to certain embodiments of the present invention, as part of an overall hydrant system, a thrust block 20 is provided at an L-shaped bend of the water pipe that directs the water upwards to the hydrant 12. The thrust block 20 serves as a way to distribute hydraulic forces of the pipe network into the soil. Small stones 22 for drainage are contained in the general vicinity of the thrust block 20. The L-shaped bend in the water pipe is further supported by flat stones or concrete slabs 26. A hydrant connection valve 24 is provided downstream from the fire hydrant 12, which is also supported by flat stones or concrete slabs 26. A downstream thrust block 28 may be provided as well. As shown in FIG. 2, the thermal insulating liner(s) 18 may extend all the way to proximal the downstream thrust block 28, which is where the supply main connection is disposed.

Embodiments of the present invention may be integrated as retrofits of existing hydrant systems, or may be incorporated as part of entirely new structures, using manufactured solar panels 16 and thermal liners 18 sized/designed for installation with the hydrant system. Conventional structure of the hydrant 12, such as a stem nut/operating stem/valve for selectively allowing water into the fire hydrant and through the hydrant outlet, and operation thereof, is not necessarily shown or further described, unless it explicitly relates to the teachings of the present invention.

By utilizing solar panels on the cap 14 of the hydrant 12, energy/electricity may be provided to a thermal liner 18 to warm the inner workings (e.g., water pipes) of the hydrant 12. Fire hydrants 12 may thus, as mentioned above, be manufactured with this technology, or they can easily be retrofitted by wrapping the insulating liner 18 around the water pipes near and above ground level and electrically connecting them to solar panels 16 mounted on the cap 14 of the hydrant 12. In use, the solar panels 16 collect solar energy and convert the solar energy to electrical energy, which is transferred to the insulating liner 18, in turn heating the water pipe(s) it is wrapped around. Thus, the pipes are kept from freezing, and a fire fighter may use the hydrant 12 as it was intended, even in the coldest of temperatures. In instances where a battery is incorporated, electrical energy is also transferred to the battery and stored for use later (such as at night, when solar energy may not be collected by the solar panels 16).

From the foregoing disclosure, it would be readily apparent to those with skill in the art that a controller and/or other sensors (not shown) may also be incorporated with the hydrant assembly 10 (such as embedded in the hydrant 12 and powered by the solar panels 16) to allow for selective operation of the insulated liner 18 (and general control of the system). For example, a controller (and any corresponding structure to achieve this end) may be configured to activate the insulated liner 18 if the temperature drops below a certain threshold, and otherwise directs power to the battery or stops the charging of the battery if it is fully charged. Of course, other configurations of the system may be employed such that the controller most efficiently manages the heated hydrant system, as needed, and these configurations are within the scope of the present disclosure.

The present invention has been described in terms of exemplary embodiments solely for the purpose of illustration. Persons skilled in the art will recognize from this description that the invention is not limited to the embodiments described but may be practiced with modifications and alterations limited only by the spirit and scope of the appended claims.

In the following claims, any labelling of elements, limitations, steps, or other parts of a claim (for example, first, second, etc., (a), (b), (c), etc., or (i), (ii), (iii), etc.) is only for purposes of clarity, and are not to be interpreted as suggesting any sort of ordering or precedence of the claim parts so labelled. If any such ordering or precedence is intended, it will be explicitly recited in the claim or, in some instances, it will be implicit or inherent based on the specific content of the claim. To further aid the USPTO and any readers of any patent issued on this application, it is additionally noted that there is no intent any of the appended claims to invoke paragraph (f) of 35 U.S.C. § 112 as it exists on the date of filing hereof unless the words “means for” or “step for” are explicitly used in the particular claim.

What is claimed is:

1. A fire hydrant assembly comprising:
a fire hydrant;
a water pipe operably connected to the fire hydrant;
a thermal insulating liner at least partially wrapped around the water pipe; and
a power source coupled to the fire hydrant and electrically connected to the thermal insulating liner.

2. The fire hydrant assembly of claim 1, wherein the power source is a renewable energy power source.

3. The fire hydrant assembly of claim 2, wherein the renewable energy power source is at least one solar panel.

4. The fire hydrant assembly of claim 3, further comprising a battery configured to receive electrical energy from the at least one solar panel.

5. The fire hydrant assembly of claim 1, wherein the thermal insulating liner surrounds a circumference of the water pipe.

6. The fire hydrant assembly of claim 1, wherein the thermal insulating liner is configured to heat the water pipe for preventing water disposed in the water pipe from freezing.

7. The fire hydrant assembly of claim 1, wherein the power source is embedded in a recess formed in the hydrant.

8. The fire hydrant assembly of claim 1, wherein the power source is at least one solar panel embedded in a cap of the fire hydrant.

9. A fire hydrant system comprising:
fire hydrant assembly comprising:
a fire hydrant;
a water pipe operably connected to the fire hydrant;
a thermal insulating liner at least partially wrapped around the water pipe; and
a power source coupled to the fire hydrant and electrically connected to the thermal insulating liner; and
a hydrant connection valve disposed under a ground surface and connected to the water pipe.

10. The fire hydrant system of claim 9, wherein the thermal insulating liner extends beyond the hydrant connection valve.

11. The fire hydrant system of claim 10, wherein the thermal insulating liner terminates proximal a supply main water pipe.

12. The fire hydrant system of claim 11, wherein the thermal insulating liner is configured to heat the water pipe for preventing water disposed in the water pipe from freezing.

13. The fire hydrant system of claim 9, wherein the power source is at least one solar panel.

14. The fire hydrant system of claim 13, further comprising a battery configured to receive electrical energy from the at least one solar panel.

15. The fire hydrant system of claim 9, wherein the power source is embedded in a recess formed in the fire hydrant.
